(19) United States
(12) Patent Application Publication
(10) Pub. No.: US 2006/0242906 A1
(43) Pub. Date: Nov. 2, 2006

(54) Reformer system and method of operating the same

(76) Inventors: John Alan MacBain, Carmel, IN (US); Gerald T. Fattic, Fishers, IN (US)

Correspondence Address: PAUL L. MARSHALL;DELPHI TECHNOLOGIES, INC., Legal Staff, Mail Code 480-410-202, P.O. Box 5052, Troy, MI, 48007-5052, US

(21) Appl. No.: 11/117,226

(22) Filed: Apr. 28, 2005

(51) Int. Cl. B01J 8/00

(52) U.S. Cl. 48/198.1; 48/127.9

(57) ABSTRACT

In one embodiment, a reformer system can comprise an exhaust treatment device, a reformer disposed upstream of and in fluid communication with the exhaust treatment device, an oxygen storage device disposed upstream of and in fluid communication with the reformer, and a first fluid moving device disposed upstream of and in fluid communication with the oxygen storage device. In anther embodiment, a reformer system can comprise an exhaust treatment device, a reformer disposed upstream of and in fluid communication with the exhaust treatment device, a reformate storage device disposed downstream of and in fluid communication with the reformer, and a fluid moving device disposed upstream of and in fluid communication with the reformate storage device.

### BACKGROUND

Federal and state governments have enacted progressive laws and regulations that impose ever-increasing restrictions on motor vehicles in the areas of exhaust emissions and improved fuel economy. For example, the California regulations include Super Ultra Low Emission Vehicle (SULEV) emission standards. It is noted that SULEV emission standards are particularly more stringent on hydrocarbon (HC) and nitrogen oxides (NOₓ) (e.g., nitric oxide (NO), nitrogen dioxide (NO₂), nitrous oxide (N₂O), and the like) emissions. Moreover, as this trend of increasingly restrictive emissions continues, Zero Emission Vehicle (ZEV) standards are eventually going to become the standard for exhaust gaseous emissions.

In order to meet exhaust gaseous emission standards, the exhaust gas emitted from internal combustion engines can be treated prior to emission into the atmosphere. Exhaust gases can be routed through an exhaust treatment device disposed in fluid communication with the exhaust outlet system of the engine, wherein the exhaust gas can be treated, for example, by reactions employing a catalyst. Examples of exhaust treatment devices include catalytic converters, catalytic absorbers/adsorbers (e.g., NOₓ adsorber, SOx adsorber, and the like), particulate traps, plasma conversion devices (e.g., non-thermal and thermal devices), oxidation catalyst devices, selective catalytic reduction (SCR) devices, and the like). Some exhaust treatment devices need to be periodically “regenerated” to remove materials that can accumulate in the device.

What is continually needed in the art are improved systems for efficiently regenerating exhaust treatment device(s).

### SUMMARY

Disclosed herein are reformer systems and methods of operating the reformer system.

One embodiment of a reformer system, comprises an exhaust treatment device; a reformer disposed upstream of and in fluid communication with the exhaust treatment device, wherein the reformer is capable of producing reformate comprising hydrogen and carbon monoxide; an oxygen storage device disposed upstream of and in fluid communication with the reformer; and a first fluid moving device disposed upstream of and in fluid communication with the oxygen storage device.

Another embodiment of a reformer system comprises an exhaust treatment device; a reformer disposed upstream of and in fluid communication with the exhaust treatment device, wherein the reformer is capable of producing a reformate comprising hydrogen; a reformate storage device disposed downstream of and in fluid communication with the reformer; and a fluid moving device disposed upstream of and in fluid communication with the reformate storage device.

One embodiment of a method of operating a reformer system comprises generating an exhaust gas; treating the exhaust gas in an exhaust treatment device; generating reformate in a reformer disposed in fluid communication with the exhaust treatment device, wherein the reformate comprises hydrogen and carbon monoxide; storing the reformate under pressure in a reformate storage device disposed downstream of and in fluid communication with the reformer; and releasing reformate from the reformate storage device to regenerate the exhaust treatment device.

Another embodiment of a method of operating a reformer system comprises generating an exhaust gas; treating the exhaust gas in an exhaust treatment device; storing oxygen in an oxygen storage device disposed upstream of a reformer; releasing the oxygen from the oxygen storage device to the reformer; generating reformate in the reformer; and introducing the reformate to the exhaust treatment device.

The above-described and other features will be appreciated and understood by those skilled in the art from the following detailed description, drawings, and appended claims.

### BRIEF DESCRIPTION OF THE DRAWINGS

Refer now to the figures, which are exemplary embodiments, and wherein the like elements are numbered alike.

FIG. 1 is a schematic illustration of a reformer system.

FIG. 2 is a schematic illustration of another embodiment of a reformer system.

### DETAILED DESCRIPTION

In some applications, a reformer can be operated in a cycle, wherein reformate can be generated for a period of time sufficient to regenerate a given exhaust treatment device followed by an inactive (rest) period. However, the cyclic operation of the reformer can cause a number of challenges for the system such as substantial power demands during “peak” operation of the reformer, thermal cycling of a reformer substrate that can damage the reformer substrate, maintaining desired operating temperature for efficient operation without hydrocarbon breakthrough, and the like.

A reformer system and method of operating the reformer system are disclosed. Briefly stated, it has been discovered that by employing a storage device and/or fluid moving device (e.g., pumps, fans, blowers, and the like) in relation to the reformer that the size of the reformer and/or the size of the fluid moving device can be decreased, which can advantageously reduce the equipment costs, peak power budget, and operating costs associated with the reformer system.

It should first be noted that the reformer disclosed herein can readily be adapted for use in any system where hydrocarbon fuels are processed to hydrogen, carbon monoxide and/or less complex hydrocarbons, such as a fuel cell system (e.g., solid oxide fuel cell (SOFC) system, proton exchange membrane (PEM) system, and the like), an internal combustion engine system (e.g., an engine system fueled with diesel fuel, gasoline, and the like), chemical processes employing hydrogen as a reactant, and the like. Additionally, it is noted that the reformer can be employed in stationary applications and can desirably also be employed in mobile applications, e.g., “on-board” applications.

The term “on-board” is used herein to refer to the production of a given component within a vehicle (e.g., automobile, truck, and the like) system. System components (e.g., devices) can also be referred to as being “in-line” or “off-line” for ease in discussion. An “in-line” device refers generally to a device disposed downstream of and in fluid communication with an exhaust gas source, wherein the “in-line” device is capable of receiving a continual flow of exhaust gas during operation. An “off-line” device refers generally to a device disposed in selective fluid communication with an exhaust gas conduit that is disposed in fluid communication with an exhaust gas source, wherein the “off-line” device generally does not receive exhaust gas from the exhaust gas source. However, embodiments are envisioned where an “off-line” component can periodically become and “in-line” component, e.g., when exhaust gas is recycled to the component.

Additionally, in describing the arrangement of components within a system, the terms “upstream” and “downstream” are used. While these terms have their ordinary meaning, it is briefly mentioned for clarity in discussion that a device can be both “upstream” and “downstream” of a given device under certain configurations, e.g., a system comprising a recycle loop. It is further noted that the terms “first,” “second,” and the like herein do not denote any order or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity).

Several combinations of reformers and exhaust treatment devices are discussed hereunder with references to individual figures. One of skill in the art will easily recognize that many of the devices of each of the embodiments are similar to or identical to each other. These various devices can be added or omitted based on various design choices. As such, various elements and/or features can be introduced in a given figure with the understanding that the systems can be modified as taught herein to include features illustrated in other embodiments. Each of these elements is first introduced in the discussion of a given figure, but is not repeated for each embodiment. Rather, distinct structure is discussed relative to each figure/embodiment.

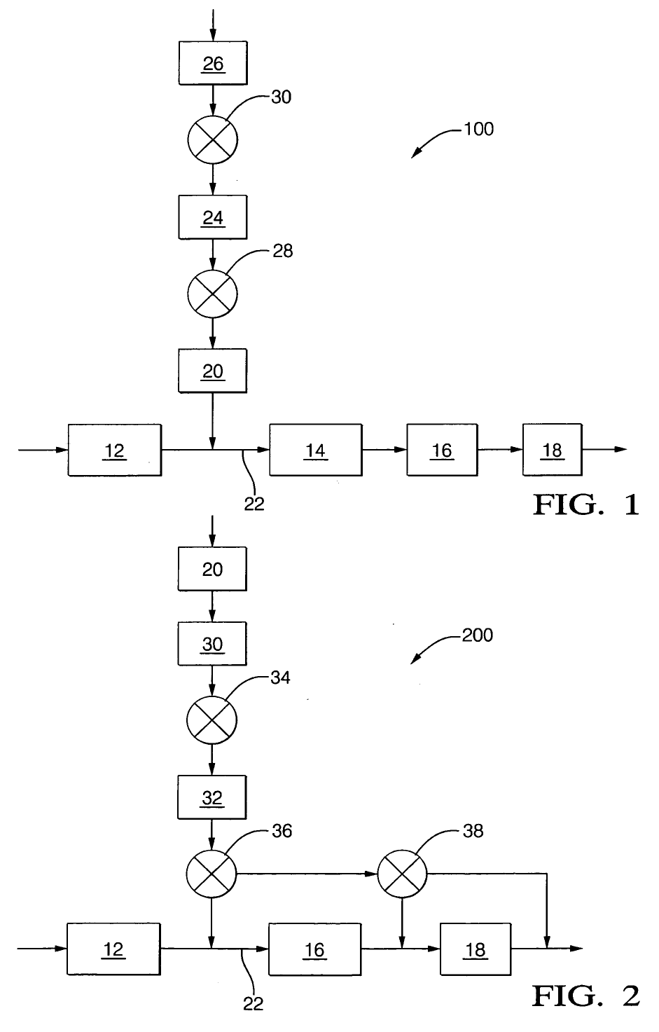

Referring now to FIG. 1, an exemplary reformer system generally designated 100 is illustrated. While the location, type, number, and size, of each component can vary depending on the application, this figure provides a starting point for discussion. An exhaust gas source 12 can be disposed upstream of and in fluid communication with at least one exhaust treatment device (e.g., an oxidation catalyst device 14, a NOₓ adsorber device 16, a particulate filter 18, and the like). For example, the exhaust gas source 12 can be disposed upstream of and in fluid communication with an in-line oxidation catalyst device 14, an in-line NOₓ adsorber device 16, and/or an in-line particulate filter 18. In a particular embodiment, the NOₓ adsorber device 16 can be disposed downstream of and in fluid communication with the oxidation catalyst device 14, while being disposed upstream of and in fluid communication with the particulate filter 18.

A reformer 20, which can be an on-board off-line reformer, can be disposed in selective fluid communication with any of the exhaust treatment devices via an exhaust conduit 22. The reformer 20 can be capable of producing reformats comprising hydrogen and carbon monoxide, which can be useful, for example, as a reducing agent to regenerate a given exhaust treatment device.

An oxygen storage device 24 (e.g., a tank, and the like) can be disposed upstream of and in selective fluid communication with the reformer 20 via an optional valve 28, which can be disposed downstream of and in fluid communication with the oxygen storage device 24 and upstream of and in fluid communication with the reformer 20. The oxygen storage device 24 can have a sufficient capacity to hold a sufficient volume of oxygen, wherein the sufficient volume of oxygen corresponds to an oxygen volume capable of enabling the production of sufficient amount of reformate to meet a peak demand. For example, the oxygen storage device can have a sufficient volume such that, in conjunction with the normal operating capacity of the first fluid moving device 26 (e.g., a pump or the like), sufficient oxygen can be introduced to the reformer to enable the reformer to produce a peak demand amount of reformate. As briefly noted above, since oxygen can be stored in the oxygen storage device 24, the size of the first fluid moving device 26 can be smaller compared to a system where oxygen is not stored. Stated another way, without the oxygen storage device 24, the first fluid moving device 26 is sized to provide the reformer 20 with a peak demand amount of oxygen. With the use of the oxygen storage device 24, the first fluid moving device 26 can operate at a steady rate well below the peak demand.

A first fluid moving device 26 can be disposed upstream of and in fluid communication with the oxygen storage device 24 such that oxygen from an oxygen source (e.g., atmospheric air, exhaust gas recycle, and the like) can be stored under pressure. The first fluid moving device 26 can be any device capable of storing the oxygen at a pressure sufficient to enable the oxygen to be introduced to the reformer from the oxygen storage device 24, e.g., a pressure greater than an exhaust gas pressure. For example, the pressure can be greater than 1 atmosphere (1 atm), particularly the pressure can be about 1.5 atm to about 2 atm, or greater, if desired.

Various valves can be employed in the system, such as one way valves, check valves, and the like. For example, an optional valve 30 can be disposed upstream of and in fluid communication with the oxygen storage device 24 and downstream of and in fluid communication with the first fluid moving device 26, e.g., to control the flow of the oxygen (e.g., to prevent backflow). As illustrated in FIG. 2, the valve(s) can be located in various locations, e.g., to enable reformate to bypass one or more exhaust treatment device(s), and/or to allow reformate to be directed to a particular exhaust treatment device, e.g., to accomplish a selective regeneration of a given exhaust treatment device.

Without being bound by theory, it is noted that system 100 can be particularly useful in applications were reformate is periodically introduced (e.g., pulsed) into the exhaust conduit 22 upstream of exhaust treatment device(s). System 100 allows oxygen to be stored under pressure in the oxygen storage device 24, and dispersed on demand to the reformer 20. Further, system 100 can provide a reduction in the size, mass, and peak power budget of at least the first fluid moving device 26 compared to systems that do not employ an oxygen storage device. This reduction can advantageously reduce the equipment costs and operating (power) costs and requirements of the system 100.

Another embodiment of a reformer system, generally designated 200, is illustrated in FIG. 2. System 200 can comprise a second fluid moving device 30 disposed in fluid communication with the reformer 20 and upstream of and in fluid communication with a reformate storage device 32. The second fluid moving device 30 is illustrated downstream of the reformer 20, but can also be disposed upstream thereof. Optional valves 34 and 36 can, respectively, be disposed upstream of and/or downstream of the reformats storage device 32 such that the valves 34, 36 can each be in selective fluid communication with the reformate storage device 32. Optional valve 38 can be disposed downstream of and in fluid communication with reformer 20 to selectively divert reformate to various exhaust treatment device(s) (e.g., particulate filter 18).

System 200 allows reformate to be stored under pressure in the reformate storage device 32 (e.g., a pressure sufficient to enable the introduction of the reformate to the exhaust stream). More particularly, without being bound by theory, system 200 advantageously can allow the reformer 20 to be continuously operated; e.g., non-stop operation while the exhaust gas source 12 is producing exhaust gas. This operation can reduce the size of the reformer 20 compared to a system where a reformer is designed to accommodate a peak demand for reformate. The reformate can be generated in the reformer 20 and introduced to the reformate storage device 32, such that the reformate can be stored and/or used on demand, wherein storage of sufficient reformate to meet peak reformate demand is possible. More particularly, the reformate storage device 32 can have a capacity to store a sufficient volume of reformate to meet the quantity of reformate desired during the peak demand period (i.e., without the need to produce additional reformate (above a standard reformate production level) to meet that demand).

Optionally, the components of system 200 can be sized to allow various operating possibilities. For example, the components of system 200 can be sized to allow approximate continuous (such as non-stop) (for example, trickle operation could be employed when the reformate storage device is near capacity to keep the reformer operating and the catalyst near a desired operating temperature; and/or the reformer could be operated within a range of production rate, with excess reformate introduced to the exhaust stream as desired); periodic stopping (e.g., stopping when there is no demand for reformate); and the like.

Various operating conditions can enhance efficiency as compared to a cycling reformer (i.e., a reformer employed to generate reformate for as set period of time followed by a set period of rest). For example, during cycling operation in a cycling reformer, the reformer catalyst can cool below a desired operating level such that fuel will be consumed to re-heat the catalyst. System 200 can eliminate the need for catalyst re-heating, which can reduce fuel consumption. By operating in a continuous mode, the efficiency of the reformer 20 can be improved (compared to systems that employ the cycling operation) since an operating temperature of the reformer 20 can be maintained within a desired window of operation. Durability of the reformer substrate and the catalyst/washcoat can also be enhanced due to the reduction of thermal cycles.

Additionally, it is to be understood that embodiments are envisioned where the reformer 20 can be continuously operated or approximately continuously operated without employing second fluid moving device 30, reformate storage device 32, and related valves 34 and 36. For example, reformer 20 can be operated to continuously disposed reformate into exhaust conduit 22 while exhaust gas is being produced. The size of the reformer can vary depending on the application (e.g., depending on the number of exhaust treatment devices consuming the reformate).

For example, reformats can be supplied to multiple exhaust treatment devices simultaneously, diverted around a given exhaust treatment device to another device, and the like. Suitable types and arrangements of exhaust treatment devices that can include, but are not limited, to those discussed in International Application No. PCT/US04/04093 (Published Application No. WO2004071646) to Kupe et al.

Turning now to each component of systems 100 and 200, it is noted that exhaust gas source 12 can include various engines (e.g., compression ignition engines, spark ignition engines, and the like), furnaces, and the like. For example, the exhaust gas source 12 can be a compression ignition engine operating with diesel fuel (e.g., a diesel engine). However, it is to be understood that other fuel sources can be employed, e.g., hydrocarbon fuel(s) such as gasoline, diesel, ethanol, methanol, kerosene, and the like; gaseous fuels, such as natural gas, propane, butane, and the like; and alternative fuels, such as hydrogen, biofuels, dimethyl ether, and the like; as well as combinations comprising at least one of the foregoing fuels.

With regards to the exhaust treatment device(s), it is noted that each exhaust treatment device in the system can be disposed in fluid communication with the exhaust source 12. The number and arrangement of the various exhaust treatment device(s) depends on the type and application of the system. Generally, each exhaust treatment device can comprise a substrate disposed within a housing. A catalyst and catalyst support material can, optionally, be disposed on, in, and/or throughout (hereinafter “on” the substrate for convenience in discussion) the substrate depending on the given device and application. For example, oxidation catalyst 14 can comprise a catalytic material(s), support material(s), and a substrate(s) disposed within a housing. Optionally, a retention material can be disposed between the substrate and the housing. The catalyst and support material can be washcoated, imbibed, impregnated, precipitated, and/or otherwise applied onto the substrate. Examples of catalyst materials can comprise include, but are not limited to, platinum, palladium, ruthenium, rhodium, iridium, gold, and silver, as well as oxides, precursors, alloys, salts, and mixtures comprising at least one of the foregoing. The particular catalyst is dependent upon the catalyst function (e.g., oxidation, etc.), and catalyst location in the exhaust stream.

Turning now to the reformer 20, the reformer 20, which can be an off-line component of the system 100, is disposed in fluid communication with the exhaust conduit 22. Embodiments are envisioned where exhaust gas recycle (EGR) can be recycled to the reformer, thereby making the reformer an “in-line” (e.g., a periodic in-line) component of the system 100. However, it is noted that a number of advantages can be recognized (e.g., greater production of hydrogen, and the like) by supplying air in addition to or as an alternative to EGR.

The reformer can comprise any device capable of generating reformate comprising primarily hydrogen and carbon monoxide (often referred to as synthesis gas or syn-gas). More particularly, greater than or equal to 80% of the total volume of reformate is hydrogen and carbon monoxide; even more particularly, greater than or equal to 90% of the reformate is hydrogen and carbon monoxide. The reformer can be configured for partial oxidation reforming, steam reforming, and/or dry reforming, and the like. In an embodiment, reformer can be configured primarily for partial oxidation reforming. However, it is noted that steam reforming and dry reforming can also occur to the extent of the water and carbon dioxide are contained in the air and fuel.

Partial oxidation reformers are based on substoichiometric combustion to achieve the temperatures sufficient to reform the fuel. Chemical “decomposition” of the fuel to synthesis gas can occur through thermal reactions at high temperatures, e.g., about 700° C. to about 1,200° C. Catalysts have been demonstrated with partial oxidation systems (catalytic partial oxidation) to promote conversion of various fuels into synthesis gas. The use of a catalyst can result in acceleration of the reforming reactions and can provide this effect at lower reaction temperatures than those that would otherwise be needed in the absence of a catalyst. An example of the partial oxidation reforming reaction is as follows:
CH₄+½O₂→CO+2H₂+heat (I)

Steam reforming involves the use of a fuel and steam (H₂O) that can be reacted in heated tubes filled with a catalyst(s) to convert the hydrocarbons into synthesis gas. The steam reforming reactions are endothermic, thus the steam reformers can be designed to transfer heat into the catalytic process. An example of the steam reforming reaction is as follows:
CH₄+H₂O→CO+3H₂ (II)

Dry reforming involves the creation of synthesis gas in the absence of water, for example, using carbon dioxide as the oxidant. Dry reforming reactions, like steam reforming reactions, are endothermic processes. An example of the dry reforming reaction is depicted in the following reaction:
CH₄+CO₂→2CO+2H₂ (III)

Practical reformers can comprise a combination of these idealized processes. Thus, a combination of air, water, and/or recycled exhaust fluid can be used as the oxidant in the fuel reforming process.

The reformer can comprise a substrate and catalyst disposed within a housing. Optionally, the substrate can be capable of operating at temperatures up to about 1,400° C.; capable of withstanding strong reducing environments in the presence of, for example, water, hydrocarbons, hydrogen, carbon monoxide, oxygen, sulfur, sulfur-containing compounds, combustion radicals (such as hydrogen and hydroxyl ions and the like), and carbon particulate matter; and has sufficient surface area and structural integrity to support the desired catalyst metal and support material. Suitable materials that can be used as the substrate include, aluminum oxide (e.g., zirconium toughened aluminum oxide, titanium toughened aluminum oxide, aluminum oxide, and the like), zirconium oxide, titanium oxide, and the like, as well as combinations, cermets, alloys, and so forth, comprising at least one of the foregoing materials.

Suitable catalysts include those discussed above in relation to the oxidation catalyst device 14. In an embodiment, the catalytic materials for reformer can comprise rhodium and platinum, as well as oxides, precursors, alloys, salts, and mixtures comprising at least one of the foregoing metals. Support materials for the reformer can include, but are not limited to, hexaaluminates, aluminates, aluminum oxides (e.g., gamma-aluminum oxide, theta-aluminum oxide, delta-aluminum oxide), gallium oxides, zirconium oxides, titanium oxides, and the like, as well as combinations, cermets, alloys, and so forth, comprising at least one of the foregoing materials.

In one mode of operation, oxygen from an oxygen source (e.g., air, EGR, and/or the like) can be stored in the oxygen storage device 24. Alternatively, or in addition, reformate can be stored in the reformate storage device 32. Here, the reformer can operate in a steady state until the reformate storage device 32 reaches a desired capacity (e.g., a desired volume and/or pressure). Hence, the reformer can be sized and can operate at a rate well below a peak demand rate (e.g., since the reformate storage device 32 will supply the amount of reformate needed to meet the peak demand). This mode of operation can facilitate continuous operation, particularly wherein the exhaust treatment system is not capable of consuming all of the reformate as it is produced or when the exhaust treatment system calls for reformate delivery in discrete pulses of flow on demand. By employing reformate storage device 32, reformate can be accumulated (stored) for use, on demand, by a given exhaust treatment device(s), while reducing the size of the reformer 20. Without being bound by theory, this mode of operation can allow the size of the reformer to be reduced compared to systems where a reformer is designed to accommodate reformate supply at peak demand periods.

Other modes of operation are envisioned where oxygen and reformate can each be stored. More particularly, oxygen can be stored in an oxygen storage device 24 disposed upstream of and in fluid communication with the reformer 20. Reformate can be stored in a reformate storage device 32 disposed downstream of and in fluid communication with the reformer 20. Without being bound by theory, this mode of operation can allow flexibility in operation, such that the reformer can be operated continuously and/or periodically. Further, this particular architecture can permit the delivery of a pulse of reformats on demand from reformate storage tank 32. A pulse generation of new reformate can be accomplished by releasing air from storage tank 24 to the reformer which can be delivered directly through reformate storage tank 32, thus increasing the peak reformate delivery capability of the system.

For example, an engine can be operated to produce power and an exhaust stream. The exhaust stream is directed through various exhaust treatment devices that reduce the concentration of various components of the exhaust stream such as carbon monoxide, hydrocarbons, particulates, and/or NOx. As the engine is running, a first fluid moving device (e.g., a pump, or the like), can direct air from the environment into an oxygen storage device where it is stored under pressure. When one or more of the exhaust treatment devices are to be regenerated, fuel and the air can be directed to the reformer where reformate is produced. The reformate can be introduced to an exhaust treatment device for regeneration of that device or to produce a component that can then be used for regeneration (e.g., the reformate can be used to form ammonia, which is used in a regeneration process).

Another operation of the system, the air can be wholly or partially stored in the oxygen storage device (partial storage refers to passing a portion of the oxygen through the oxygen storage device to the reformer while retaining another portion of the oxygen within the reformer). In this embodiment, oxygen (e.g., air) can be directed from the oxygen storage device at any point in time (regardless of the regeneration cycle of the exhaust treatment device(s)). The oxygen can be reacted with fuel to form reformate which can be wholly or partially stored and/or can be reacted to produce ammonia (or the like), and then wholly or partially stored.

Advantageously, as mentioned above, the systems and modes of operation disclosed herein can allow for a reduction in equipment costs, peak power budgets, and operating costs associated with the reformer system. More particularly, embodiments are envisioned wherein a greater than 50% reduction in the size of a reformer substrate is possible compared to systems that do not operate continuously and/or do not employ a reformate storage device that is capable of storing reformate under pressure. Size reductions of greater than or equal to about 70%, greater than or equal to about 80%, and even greater than or equal to about 90% are possible, for example, an order of magnitude size reduction. As the size of the reformer substrate decreases, the amount of catalyst metal employed can also decrease, which reduces the overall cost of the device. This reduction in catalyst metal holds future significance in that the catalyst materials are generally rare materials.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A reformer system, comprising:
an exhaust treatment device;
a reformer disposed upstream of and in fluid communication with the exhaust treatment device, wherein the reformer is capable of producing reformate comprising hydrogen and carbon monoxide;
an oxygen storage device disposed upstream of and in fluid communication with the reformer; and
a first fluid moving device disposed upstream of and in fluid communication with the oxygen storage device.

2. The reformer system of claim 1, further comprising a reformate storage device disposed downstream of and in fluid communication with the reformer.

3. The reformer system of claim 2, further comprising a second fluid moving device disposed upstream of and in fluid communication with the reformate storage device.

4. The reformer system of claim 1, wherein the reformer is an on-board reformer.

5. The reformer system of claim 1, wherein the oxygen storage device is disposed in fluid communication with an oxygen source, wherein the oxygen source is exhaust gas recycle, atmospheric air, or a combination comprising at least one of the foregoing.

6. The reformer system of claim 1, further comprising an exhaust gas source disposed upstream of and in fluid communication with the exhaust treatment device, wherein the exhaust gas source is selected from a furnace, a compression ignition engine, and a spark ignition engine.

7. The reformer system of claim 1, wherein the reformer is in selective fluid communication with the exhaust treatment device.

8. A reformer system comprising:
an exhaust treatment device;
a reformer disposed upstream of and in fluid communication with the exhaust treatment device, wherein the reformer is capable of producing a reformate comprising hydrogen;
a reformate storage device disposed downstream of and in fluid communication with the reformer; and
a fluid moving device disposed upstream of and in fluid communication with the reformate storage device.

9. The reformer system of claim 8, wherein the reformer is in selective fluid communication with the exhaust treatment device.

10. The reformer system of claim 8, wherein the fluid moving device is disposed downstream of the reformer.

11. The reformer system of claim 8, wherein the fluid moving device is disposed upstream of the reformer.

12. The reformer system of claim 8, further comprising an oxygen storage device dispose upstream of and in fluid communication with the reformer.

13. The reformer system of claim 8, wherein the reformer is an on-board reformer.

14. A method of operating a reformer system comprising:
generating an exhaust gas;
treating the exhaust gas in an exhaust treatment device;
generating reformate in a reformer disposed in fluid communication with the exhaust treatment device, wherein the reformate comprises hydrogen and carbon monoxide;
storing the reformate under pressure in a reformate storage device disposed downstream of and in fluid communication with the reformer; and
releasing reformate from the reformate storage device to regenerate the exhaust treatment device.

15. The method of claim 14, wherein the reformer is operated continuously while the exhaust gas is being generated.

16. The method of claim 14, further comprising storing oxygen in an oxygen storage device disposed upstream of and in fluid communication with the reformer.

17. A method of operating a reformer system comprising:
generating an exhaust gas;
treating the exhaust gas in an exhaust treatment device;
storing oxygen in an oxygen storage device disposed upstream of a reformer;
releasing the oxygen from the oxygen storage device to the reformer;
generating reformate in the reformer; and
introducing the reformate to the exhaust treatment device.

18. The method of claim 17, further comprising regenerating the exhaust treatment device with the reformate.
